(19) United States
(12) Patent Application Publication
(10) Pub. No.: US 2023/0012113 A1
(43) Pub. Date: Jan. 12, 2023

(54) INSTRUMENTED VEHICLE STORAGE CAPSULE AND SYSTEM

(71) Applicant: ALPEN STORAGE, INC., Charlottesville, VA (US)

(72) Inventor: Eric PEARSON, Charlottesville, VA (US)

(73) Assignee: ALPEN STORAGE, INC., Charlottesville, VA (US)

(21) Appl. No.: 17/944,363

(22) Filed: Sep. 14, 2022

Related U.S. Application Data
(63) Continuation-in-part of application No. 16/070,335, filed on Jul. 16, 2018.
(60) Provisional application No. 62/279,754, filed on Jan. 16, 2016.
(60) Provisional application No. 62/357,311, filed on Jun. 30, 2016.

(51) Int. Cl. E04H 6/00; B62J 19/00

(52) U.S. Cl. CPC E04H 6/005; B62J 19/00

(57) ABSTRACT

This invention relates to storage devices, particularly to storage devices for storing and protecting vehicles, and more particularly to instrumented storage capsules for storing and protecting bicycles and/or motorcycles. In one aspect of the present invention, a storage device may include an enclosure which may be sealed and/or closed off to the outside environment, and may further include a compact, at least partially nesting structure. In an exemplary embodiment, the nesting structure may include a plurality of segments that may form the enclosure, where some of the segments may nest into another to open the enclosure while maintaining the compact form-factor of the structure.

### CROSS REFERENCE TO RELATED APPLICATIONS

This application is a continuation-in-part (CIP) of U.S. Pat. App. Ser. No. 6/070,335 (U.S. Pub. No. 20190016404), which is a national-phase PCT application claiming priority to PCT/US17/13679 filed Jan. 16, 2017 claiming priority to U.S. Provisional Pat. App. Ser. No. 62/279,754 filed Jan. 16, 2016 and U.S. Provisional Pat. App. Ser. No. 62/357,311 filed Jan. 30, 2016, the entire contents of each of which are incorporated herein fully by reference.

### TECHNICAL FIELD

This invention relates to storage devices, particularly to storage devices for storing and protecting vehicles, and more particularly to storage devices for storing and protecting bicycles, including pedal bicycles and motorcycles and other wheeled vehicles of any nature whether powered or unpowered, and a related surveillance and management system. It is additionally understood that the present invention relates to storage structures with enhanced management systems and which are not limited to use in storage of a vehicle but may be useful for any type of storage.

### BACKGROUND

This section of this document introduces information about and/or from the art that may provide context for or be related to the subject matter described herein and/or claimed below. It provides background information to facilitate a better understanding of the various aspects of the technology described below. This is a discussion of “related” art. That such art is related in no way implies that it is also “prior” art. The related art may or may not be prior art. The discussion in this section of this document is to be read in this light, and not as admissions of prior art.

Bicycles, including pedal bicycles and various types of motorcycles, require proper storage and protection to prevent deterioration of components due to exposure to the elements and to deter theft. Many individuals can store these vehicles in garages or storage structures, but many others do not possess these options. Moreover, even in such structures, there may not be adequate protection and the vehicles may get in the way, be unsightly or may be subject to damage from cars or other objects. There is, therefore, a continuing need for more functional, effective, and networked storage devices for bicycles and other types of vehicles including rental vehicles.

### SUMMARY

This invention relates to storage devices, particularly to storage devices for storing and protecting vehicles, and more particularly to storage devices for storing and protecting bicycles, including pedal bicycles and various types of motorcycles, and other vehicles.

In one aspect of the present invention, a storage device may include an enclosure which may be sealed and/or closed off to the outside environment, and may further include a compact, at least partially nesting structure. In an exemplary embodiment, the nesting structure may include a plurality of segments that may form the enclosure, where some of the segments may nest into another to open the enclosure while maintaining the compact form-factor of the structure.

The storage device may generally be constructed from any appropriate materials, but may generally include rigid and/or durable materials to provide integrity and protection to the contents. Appropriate materials may include, but are not limited to, metals and alloys, composite materials, polymeric materials, naturally-derived materials such as wood, and/or any other appropriate material or combination thereof. The structure of the storage device may also include, for example, structural reinforcements or supports. These may be desirable to, for example, increase rigidity, increase durability and/or strength, provide guides or tracks for moving components, and/or other benefits.

In some embodiments, the nesting structure may generally have the form of a half circle or arch, where the flat portion of the structure may rest on the ground or other surface. The structure may also include stabilizing and/or supporting features or structures, such as feet and/or cross-stabilizers. The stabilizing and/or supporting features or structures may also be movable, such as for retracting during non-use.

In some embodiments, the nesting structure may include a plurality of segments which may rotate and/or pivot on a central common axis or pivot point.

The segments may further include stops and/or other features for controlling the extent of movement and/or articulation of the segments to, for example, prevent the segments from moving beyond their intended positioning.

In another aspect of the present invention, a storage device may further include wheel holders and/or other features for retaining a wheeled vehicle, such as, for example, various types of bicycles, such as a road bicycle, a mountain bicycle, a triathlon/time trial bicycle, a motorcycle, a recumbent bicycle, a hybrid bicycle, and/or any other common wheeled vehicle, in a desired orientation and position within the storage device. For example, wheel tracks or holders, frame holders, bumpers, cushioning and/or any other appropriate feature or combination thereof may be utilized to hold a wheeled vehicle within the storage device. In general, it may be desirable to employ adjustable and/or flexible features to accommodate a variety of different vehicles, sizes or variations.

In a further aspect of the present invention, a storage device may also include features for aiding or assisting a user in inserting and/or removing a wheeled vehicle from the storage device. In some embodiments, the storage device may include an aperture or opening at ground level such that a wheeled vehicle may be rolled into and/or out of the storage device without lifting. In some other embodiments, the storage device may include an assist feature, such as a ramp, incline, ledge or other graduating feature such that a wheeled vehicle may be rolled up the feature into the storage device.

The present invention together with the above and other advantages may best be understood from the following detailed description of the embodiments of the invention, and as illustrated in the drawings.

It will be understood that specific embodiments may include a variety of features and options in different combinations, as may be desired by different users. Practicing the invention does not require utilization of all, or any particular combination, of these specific features or options. The specific techniques and structures for implementing particular embodiments of the invention and accomplishing the associated advantages will become apparent from the following detailed description of the embodiments and the appended drawings and claims.

The above presents a simplified summary in order to provide a basic understanding of some aspects of the invention. This summary is not an exhaustive overview of the invention. It is not intended to identify key or critical elements of the disclosure or to delineate the scope of the invention. Its sole purpose is to present some concepts in a simplified form as a prelude to the following more detailed description, appended drawings, and claims.

### BRIEF DESCRIPTION OF THE FIGURES

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIGS. 1, 1a and 1b illustrate a side view, a front view and a top view of an embodiment of a storage device in some embodiments of the present invention.

FIG. 1c illustrates a side view of an embodiment of a storage device without reinforcing ribs in some embodiments of the present invention.

FIGS. 1d and 1e illustrate side views of an embodiment of a storage device with unidirectional moving segments.

FIGS. 1f and 1g illustrate an opening and closing control mechanism.

FIG. 1h illustrates reinforcing ribs on the interior of a storage device.

FIG. 2 illustrates an exploded view of a storage device in some embodiments of the present invention.

FIGS. 2a and 2b illustrate a closure and securing feature.

FIGS. 3, 3a and 3b illustrate the stages of opening of a storage device in some embodiments of the present invention.

FIG. 4 illustrates a see-through view of a storage device with a bicycle enclosed and held with a wheel track and frame holder.

FIGS. 5 and 5a illustrate stabilizing features.

FIG. 6 is a side view of an instrumented vehicle storage capsule in the closed position.

FIG. 7 is a cut-away side view of the instrumented vehicle capsule in the closed position showing a bicycle inside the capsule.

FIG. 8 is a cut-away perspective view of the instrumented vehicle capsule in open position showing a bicycle inside the capsule.

FIG. 9 is front-top perspective view of the instrumented vehicle capsule in the closed position.

FIG. 10 is rear-bottom perspective view of the instrumented vehicle capsule in the closed position.

FIG. 11 is front-top perspective view of the instrumented vehicle capsule in the open position.

FIG. 12 is rear-bottom perspective view of the instrumented vehicle capsule in the open position.

FIG. 13 is an instrumentation diagram for a surveillance and management system for the instrumented vehicle storage capsules and associated vehicles.

FIG. 14 is an elevational view of a retail bay containing multiple the instrumented vehicle storage capsules and associated bicycles.

FIG. 15 is a functional block diagram of a management system for multiple the instrumented vehicle storage capsules and associated bicycles.

FIG. 16 is a functional block diagram of a mobile device in the management system.

FIG. 17 is a functional block diagram of a mobile workstation in the management system.

FIG. 18 is a conceptual diagram illustrating features of the instrumented vehicle storage capsule.

While the invention is susceptible to various modifications and alternative forms, the drawings illustrate representative embodiments of the invention by way of example. It should be understood, however, that the description of specific examples is not intended to limit the invention to the particular forms disclosed, but on the contrary, the intention covers all modifications, equivalents, and alternatives falling within the spirit and scope of the invention as defined by the appended claims.

### DESCRIPTION OF ILLUSTRATIVE EMBODIMENTS

The detailed description set forth below is intended as a description of the presently exemplified devices, methods and materials provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

This invention relates to storage devices, particularly to storage devices for storing and protecting vehicles, and more particularly to storage devices for storing and protecting bicycles and/or motorcycles.

The invention may, for example, be embodied in a storage device for a wheeled vehicle comprising: a plurality of segments joined at a common pivot, each of the segments forming a portion of a semi-circular enclosure having an internal compartment sized to accommodate at least one wheeled vehicle; wherein the plurality of segments pivot on the common pivot to nest together to open and de-nest to close the semi-circular enclosure.

In one aspect of the present invention, a storage device includes an enclosure which may be sealed and/or closed off to the outside environment, and may further include a compact, at least partially nesting structure. In an exemplary embodiment, the nesting structure may include a plurality of segments that may form the enclosure, where some of the segments may nest into another to open the enclosure while maintaining the compact form-factor of the structure.

A representative embodiment of the invention includes a storage device with a base portion forming a walled container in a substantially semi-circular shape with a common pivot and an opening which forms a truncation of the substantially semi-circular shape; a first segment which pivots on the common pivot and fits over the base portion, the first segment being shaped to partially fill in the truncation; a second segment which pivots on the common pivot and fits over the base portion and is sized to nest in the first segment, the second segment being shaped to fill in a remainder of the truncation; wherein the first and second segments pivot on the common pivot to nest together to open and de-nest to close the opening.

Another representative embodiment of the invention includes a storage device with a base portion forming a walled container in a substantially semi-circular shape with a common pivot and an opening which forms a truncation of the substantially semi-circular shape; a first segment which pivots on the common pivot and fits over the base portion, the first segment being shaped to partially fill in the truncation; a second segment which pivots on the common pivot and fits over the base portion and shaped to abut first segment, the second segment being shaped to partially fill in a remainder of the truncation; a third segment which pivots on the common pivot and fits over the base portion and is sized to nest in the second segment, the third segment being shaped to fill in the remainder of the truncation; wherein the first, second and third segments pivot on the common pivot to nest together to open and de-nest to close the opening.

According to an aspect of the representative embodiment, the storage device is shaped and sized to enclose a wheeled vehicle selected from the group consisting of a road bicycle, a mountain bicycle, a triathlon/time trial bicycle, a motorcycle, a recumbent bicycle and a hybrid bicycle.

Additional aspects of the representative embodiment include a handle for controlling the nesting and de-nesting, a gearing mechanism which couples the movement of the segments together at a particular rate or ratio, a locking mechanism for securing the storage device in a closed state, a stabilizer which is attached at the bottom of the storage device to provide protection from tipping over. For example, the stabilizer may be attached at the bottom of the storage device to provide protection from tipping over, the stabilizer rotating on a pivot to deploy for use and may orient within the footprint of the storage device when not in use.

According to another aspect of the representative embodiment, the storage device is constructed from weather or outdoor resistant materials. Additional aspects of the representative embodiment include a wheel holding features, the first and second segments the are substantially the same size, and feet attached at the bottom of the storage device.

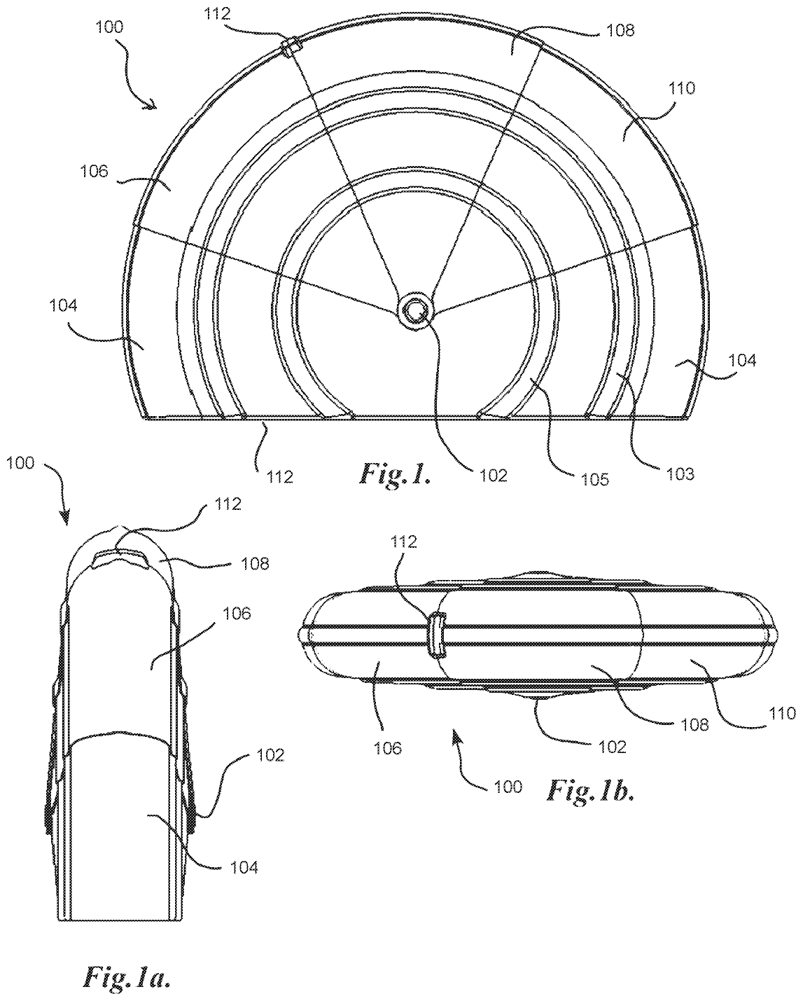

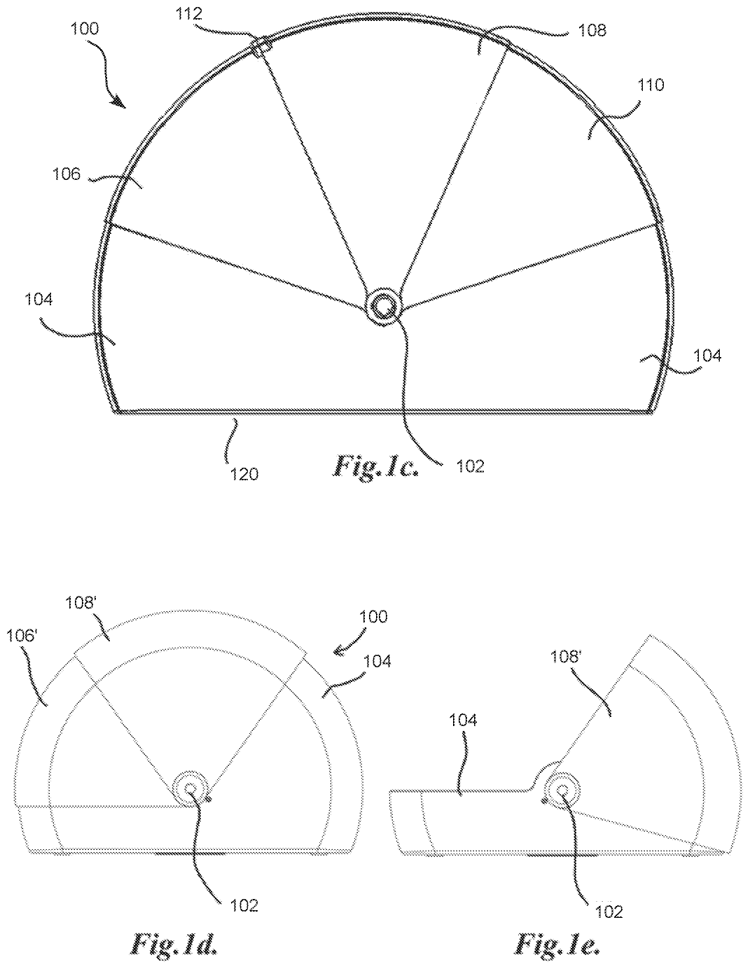

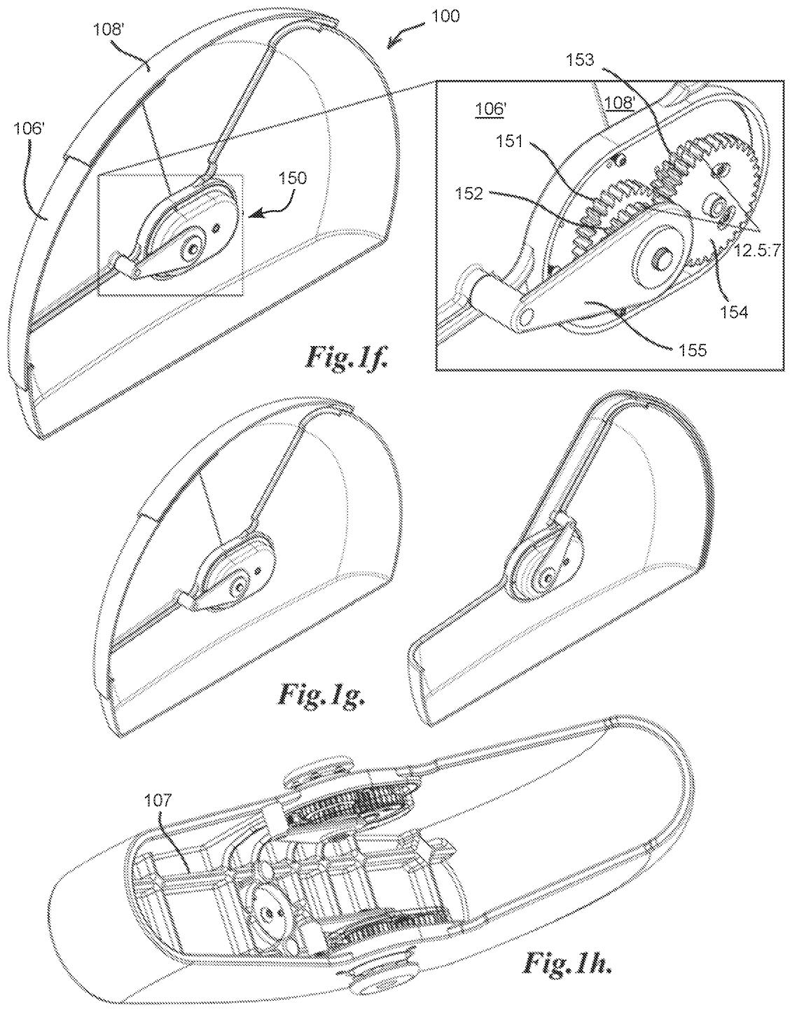

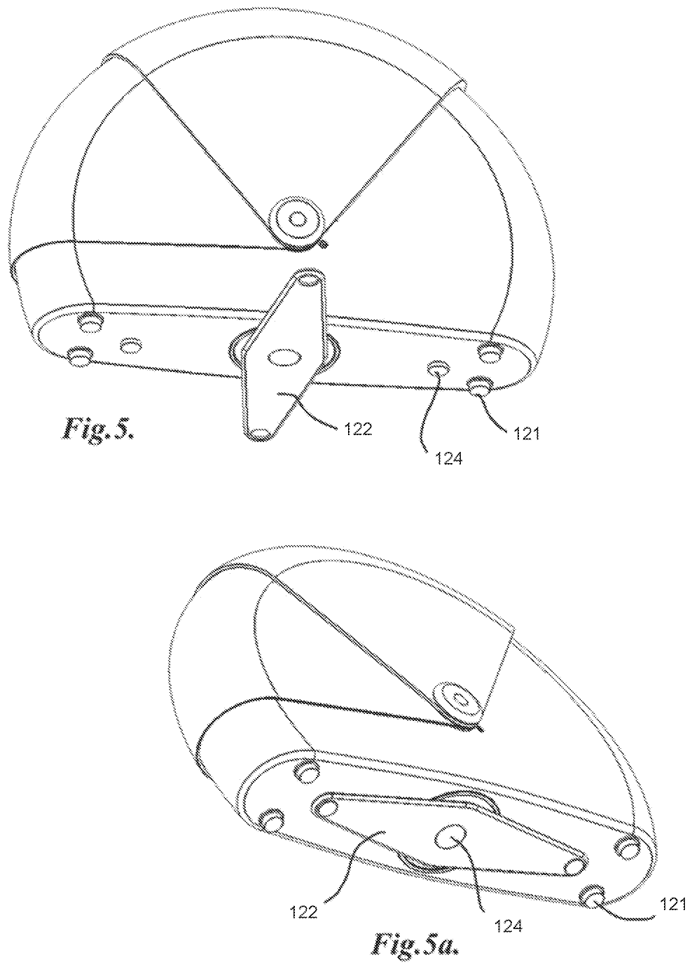

FIGS. 1, 1a and 1b illustrate an embodiment of a storage device 100 which may include a plurality of segments 104, 106, 108, 110 forming an enclosure with a base 120. In some embodiments, the nesting structure may generally have the form of a half circle or arch, where the flat portion of the structure may rest on the ground or other surface. The storage structure 100 may also include feet and/or stabilizers, such as illustrated with feet 121 and cross-stabilizer 122 in FIGS. 5 and 5a. The cross-stabilizer 122 may also be movable, such as rotating on pivot 123, such that it may be stored within the boundary of the storage device 100 and deployed for a stabilizing role, such as illustrated in FIGS. 5a and 5, respectively. The cross-stabilizer 122 may further interface with retention features to hold it place when not in use, such as with retention stubs 124.

In some exemplary embodiments, as illustrated, the segments 104, 106, 108, 110 may generally form a semi-circle or circular segment and which may pivot and/or rotate about a common pivot point 102. At least a portion of the segments 104, 106, 108, 110 may generally be linked to one another such that movement and/or articulation of one segment may affect movement and/or articulation of the others. For example, segments 108, 110 may be linked such that only two segments may need to be directly handled to effect opening and/or closing of the storage device 100, such as with segments 106 and 108 via handles at closure 112. In another example, such as illustrated in FIGS. 1d and 1e, only one segment may need to be directly handled to effect opening and/or closing of the storage device, as shown with storage device 100 with segments 106′, 108′, with segment 106′ nesting within segment 108′ when opening the storage device 100.

In some embodiments, the storage device 100 may also include a mechanism for opening and/or closing. For example, a crank and/or other mechanism may be employed to control and effect the opening and/or closing of the storage device 100. In some embodiments, the mechanism may be utilized to ensure proper articulation of the segments of the storage device 100 during opening and/or closing. FIG. 1f illustrates an example of a mechanism 150 for articulating the segments of the storage device 100. In general, the mechanism 150 may cause articulation of all of the segments that are movable regardless of which segment is handled and/or moved by a user. For example, a coupling mechanism may be utilized where the rotation of one segment about the pivot 102 may cause rotation of another segment about the pivot. FIG. 1f illustrates a first gear 151 coupled to a first segment 108′ and a second gear 152 coupled to a second segment 106′. The first and second gears 151, 152 may further be coupled together by transmission gears 153, 154 which may alter the gear ratio between the first and second gears 151, 152. This may be desirable such that each segment rotates to a desired degree, for example, with segment 106′ rotating 125 degrees and segment 108′ rotating 70 degrees for the storage device 100 to be opened completely, as illustrated in FIGS. 1f and 1g, with a gear ratio of 1:1 for coupled gears 151, 153, where gear 153 and 154 rotate together, and a gear ratio of 12.5:7 for gears 154, 152. Other ratios and degrees of rotation may also be utilized depending on the shape of the segments and degree of opening of the storage device 100. The gears 151, 152 may be directly coupled to the segments 108′, 106′, for example, or they may be coupled in other manners, such as with gear 152 being coupled to segment 106′ via a crank arm 155, as illustrated in FIG. 1f.

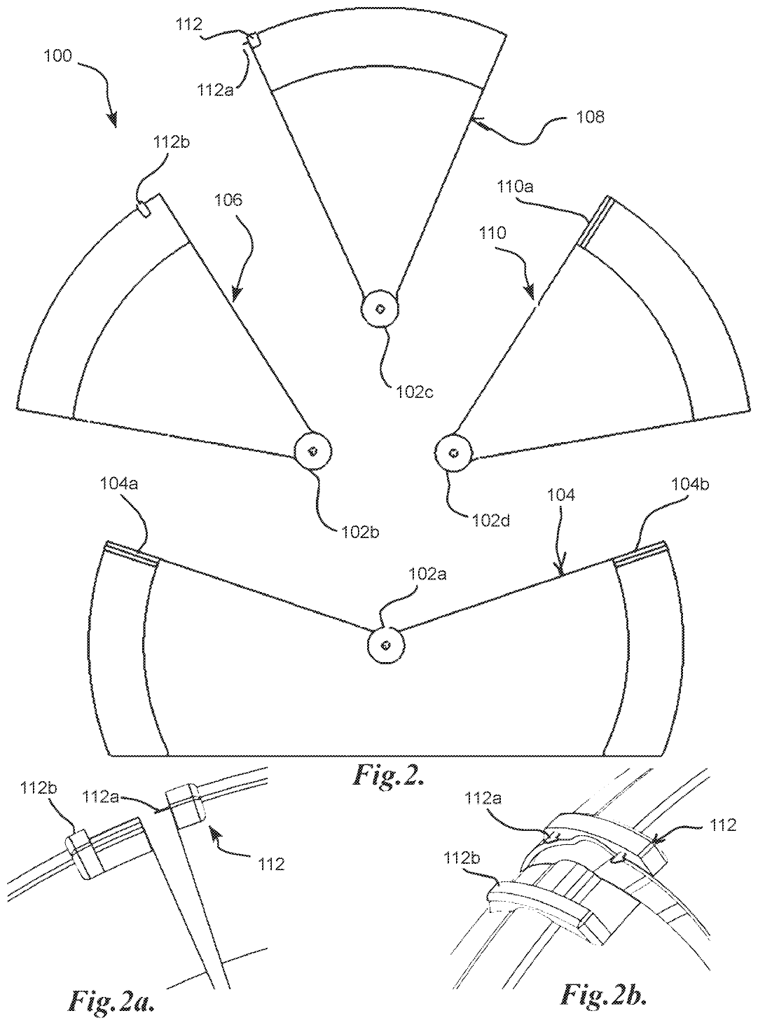

The components of the storage device 100, such as segments 104, 106, 108, 110, 106′, 108′ may be formed as completely independent elements, as illustrated in the exploded view of FIG. 2 and FIG. 2c.

The storage device may generally be constructed from any appropriate material, but may generally include rigid and/or durable materials to provide integrity and protection to the contents. Appropriate materials may include, but are not limited to, metals and alloys, composite materials, polymeric materials, naturally-derived materials such as wood, and/or any other appropriate material or combination thereof. The structure of the storage device may also include, for example, structural reinforcements or supports. These may be desirable to, for example, increase rigidity, increase durability and/or strength, provide guides or tracks for moving components, and/or other benefits.

FIG. 1 illustrates a storage device 100 with reinforcements, as illustrated with reinforcing ribs 103, 105, which may be present on the outer surface of the storage device 100, as illustrated on the outside of the segments 104, 106, 108, 110, or they may also be internal to the enclosure on the inner surface of the segments. They may also be present on a portion of the segments rather than all of them. The corresponding reinforcing ribs 103, 105 on the segments 104, 106, 108, 110 may also generally fit into corresponding depressions or tracks on the segments such that the reinforcing ribs 103, 105 may serve as guide tracks for the segments during movement or articulation to, for example, aid in maintaining the alignment of the segments. Reinforcing ribs and/or other reinforcements may also be present on the interior of the storage device 100, as illustrated in FIG. 1h.

The storage device 100 may also not include reinforcements, such as illustrated in FIG. 1c with storage device 100 without reinforcing ribs. This may, for example, simplify construction and/or create a different aesthetic appearance for the storage device 100 and, depending on, for example, the material used for construction, reinforcements may not be especially necessary.

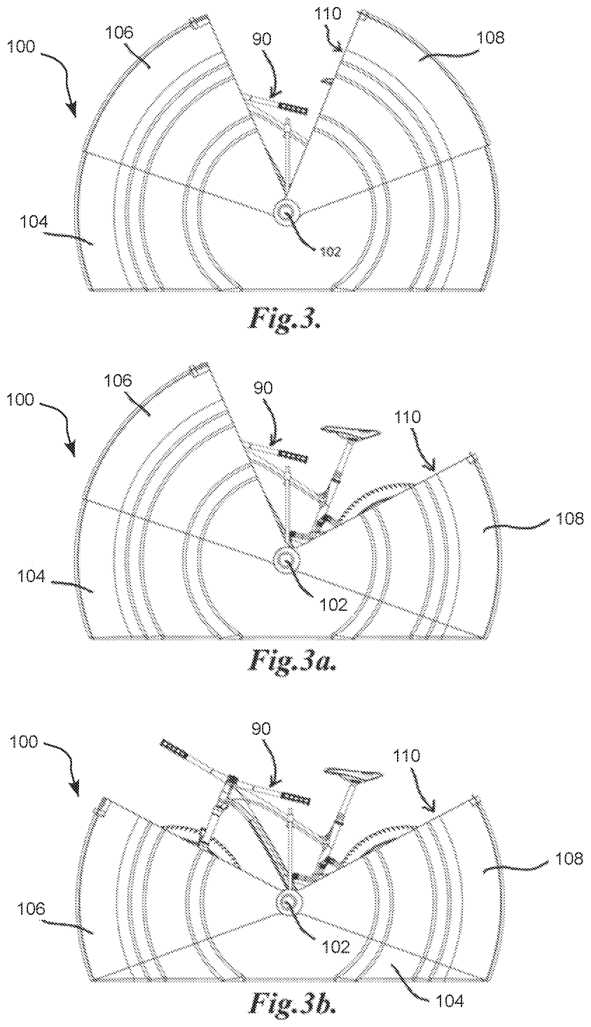

In some embodiments, the nesting structure may include a plurality of segments which may rotate and/or pivot on a central common axis or pivot point. In general, some of the segments may be sized such that they may nest into at least one other segment when they are rotated and/or pivoted about the common axis or pivot point. FIGS. 3, 3a and 3b illustrate the storage device 100 with a wheeled vehicle inside, as shown with a mountain bicycle 90, with nesting segments in phases of opening from partially open in FIG. 3, more open in FIG. 3a and fully open in FIG. 3b, where segment 110 fits into segment 108, and segments 106, 108, 110 fit over segment 104, as shown with segment 110 nesting into segment 108 in FIG. 3, segments 108, 110 nesting and fitting over segment 104 in FIG. 3a, and segments 106, 108, 110 fitting over segment 104. In general, the segments which meet to close the storage device 100 may have the same size and/or dimensions such that they mate to form a matching seal, such as with segments 106, 108 being the same size.

The segments may further include stops and/or other features for controlling the extent of movement and/or articulation of the segments to, for example, prevent the segments from moving beyond their intended positioning. FIG. 2 illustrates stops 104a, 104b on segment 104 for preventing segments 106 and 110 from extending past them, respectively.

In exemplary embodiments, a locking and/or secure closure may also be included for security of the contents of the storage device, as well as, for example, aiding in closing off the interior of the storage device from the outside. FIGS. 2, 2a and 2b illustrate a closure 112 with securing features, such as the snap-ins 112a which snap into corresponding apertures in the handle portion 112b of the closure. Other securing features may also be employed, such as, for example, magnetic elements, latches, buckles, and/or any other appropriate form of securing feature. Additional features for securing, such as those accommodating a lock or other security feature, may also be included.

In another aspect of the present invention, a storage device may further include wheel holders and/or other features for retaining a wheeled vehicle, such as, for example, various types of bicycles, including a road bicycle, a mountain bicycle, a triathlon/time trial bicycle, a motorcycle, a recumbent bicycle, a hybrid bicycle, and/or any other common wheeled vehicle, in a desired orientation and position within the storage device. For example, wheel tracks or holders, frame holders, bumpers, cushioning and/or any other appropriate feature or combination thereof may be utilized to hold a wheeled vehicle within the storage device. In general, it may be desirable to employ adjustable and/or flexible features to accommodate a variety of different vehicles, sizes or variations.

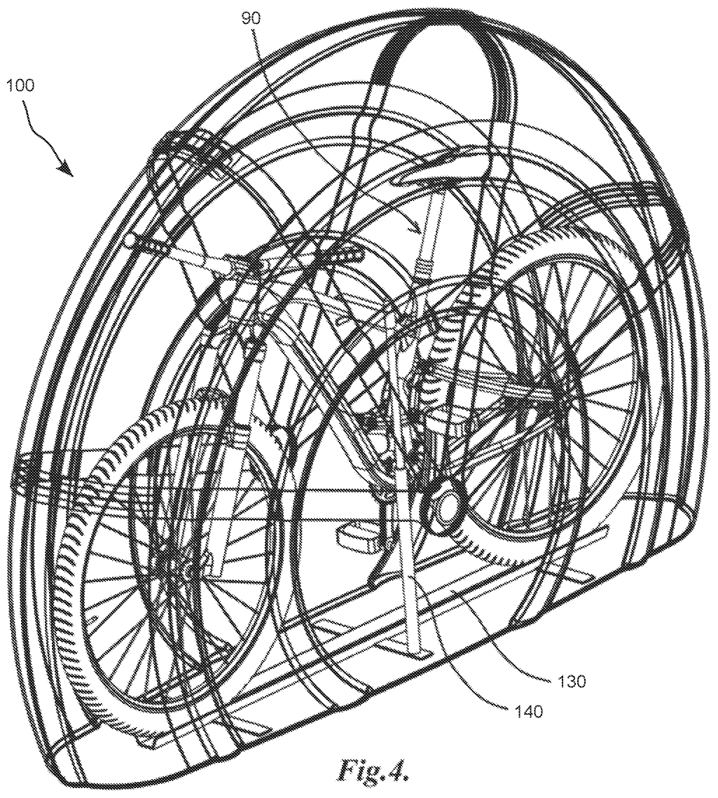

FIG. 4 illustrates a see-through view of the storage device 100 with wheel and frame holders, illustrated with wheel track 130 and frame holder 140 for retaining the bicycle 90.

In a further aspect of the present invention, a storage device may also include features for aiding or assisting a user in inserting and/or removing a wheeled vehicle from the storage device. In some embodiments, the storage device may include an aperture or opening at ground level such that a wheeled vehicle may be rolled into and/or out of the storage device without lifting. In some other embodiments, the storage device may include an assist feature, such as a ramp, incline, ledge or other graduating feature such that a wheeled vehicle may be rolled up the feature into the storage device.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. The disclosures of all patents, patent applications and publications cited herein are hereby incorporated herein by reference in their entireties, to the extent that they are consistent with the present disclosure set forth herein.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein, the meaning of “in” includes “in” and “on” unless the context clearly dictates otherwise.

Additional instrumented representative embodiments of the invention and an associated management system are described below. In general, the same or similar reference numerals are used in the drawings and the description to refer to the same or like parts or steps.

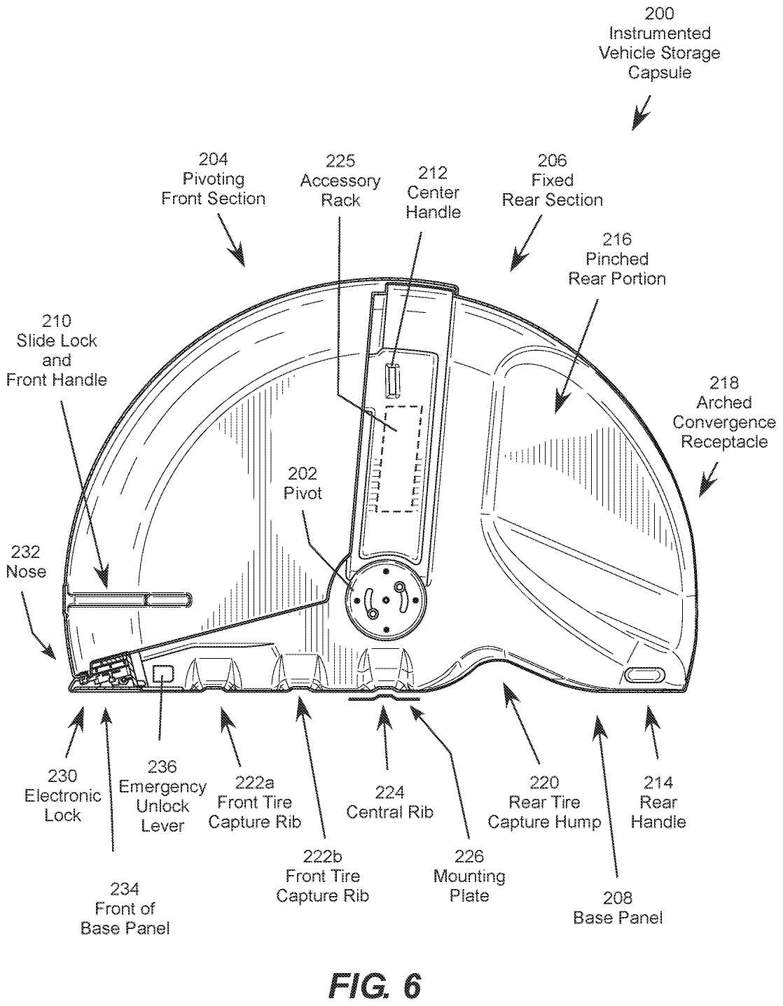

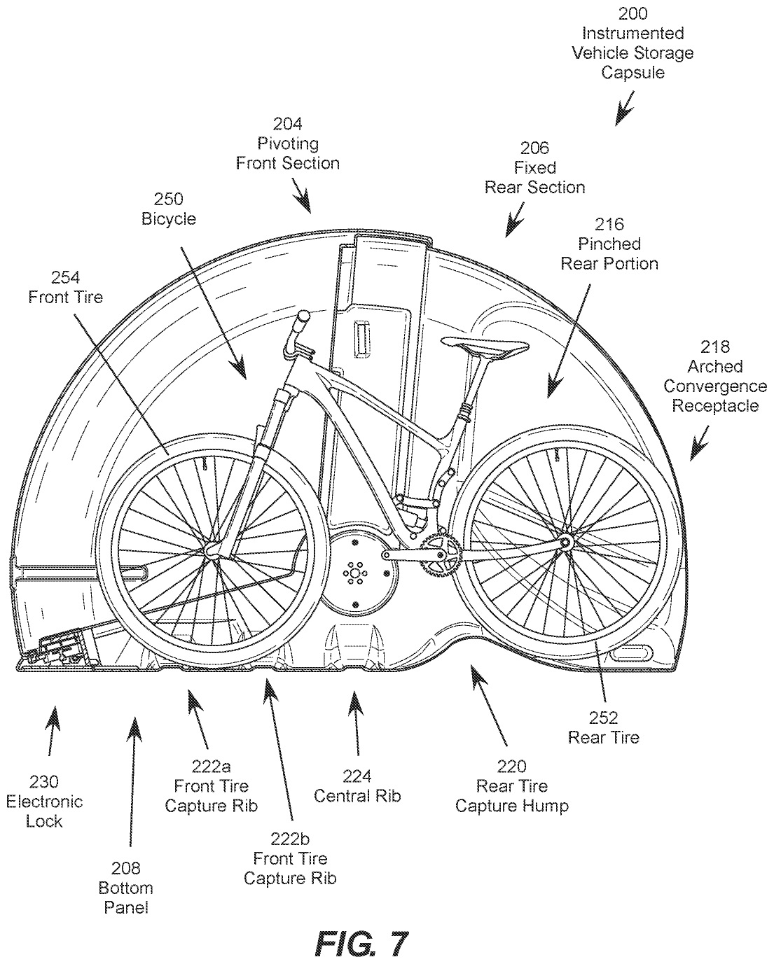

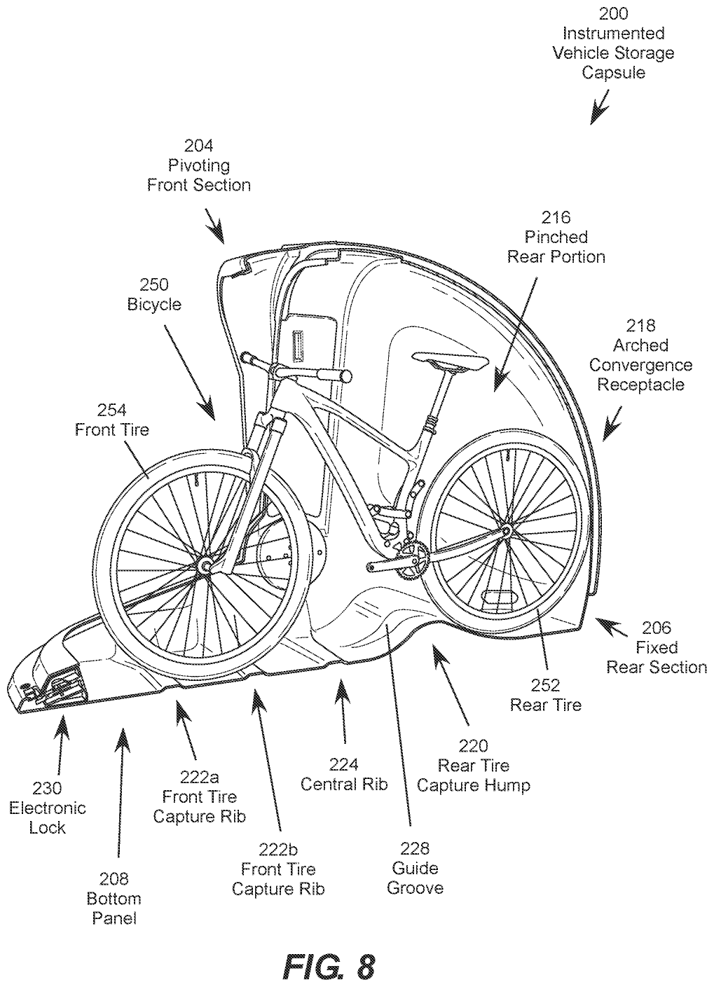

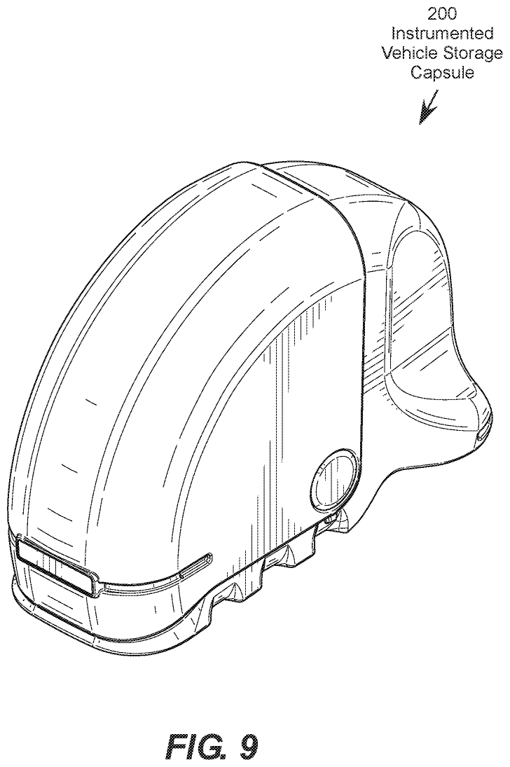

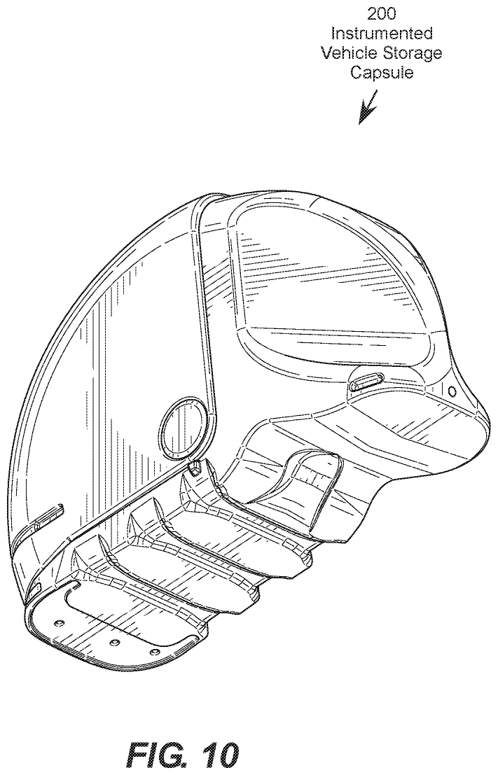

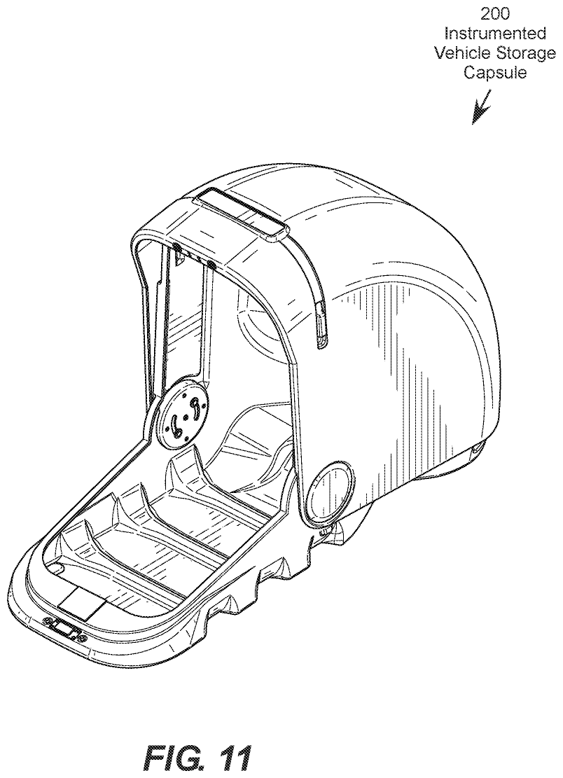

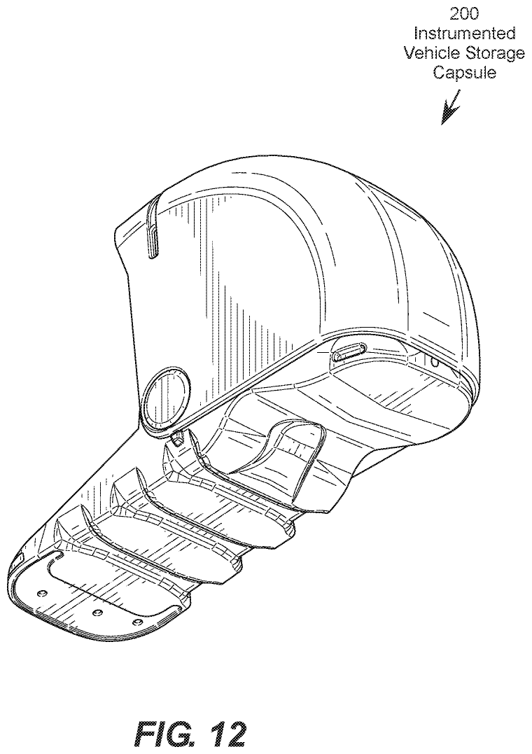

FIG. 6 is a side view of an instrumented vehicle storage capsule 200 including a pivot 202 with adjustable retention force and torque, a pivoting front section 204, and a fixed rear section 206 carried on top of a base panel 208 in the closed position. FIG. 7 is a cut-away side view of the instrumented vehicle capsule 200 in the closed position showing a bicycle 250 inside the capsule, and FIG. 8 is a cut-away perspective view of the instrumented vehicle capsule in open position also showing the bicycle. FIGS. 9-12 show additional perspective views of the capsule 200 in the closed and open positions. In the closed position shown in FIGS. 6 and 7, the pivoting front section 204, the fixed rear section 206, and the base panel 208 create a substantially enclosed capsule 200 for removably supporting and securing a vehicle, in this particular embodiment the bicycle 250. The capsule 200 includes a slide lock and front handle 210 and a center handle 212 that a user grasps to manually rotate the pivoting section 204 on the pivot 202 to nest the pivoting front section 204 over the fixed rear portion 206 to open the capsule, as shown in FIG. 8. This embodiment also includes a rear handle 214 to assist in manually lifting the capsule to move it about. The slide lock and front handle 210 includes an arcuate channel that extends around to the front nose of the pivoting front section 204, while the additional center and rear handles are located on the opposing side of the capsule 200 to provide multiple handholds on the pivoting front section to facilitate opening and closing the capsule 200. As shown in FIG. 6, the inside of the fixed rear section 206 carries an accessory rack 225 for conveniently storing various items, such as a helmet, water bottle, power bars, smartphone, keys, eyeglasses, towel, etc.

To support a bicycle 250 upright without the need for tie-down straps or tire support channels, the fixed rear section 206 defines a pinched rear portion 216 creating an arched convergence receptacle 218 for receiving a bicycle tire. In this representative embodiment, the arched convergence receptacle 218 is designed to form a snug interference fit with the rear tire 252 of the bicycle 250 as it reaches the end of its travel when backed into the capsule 200. The interference fit between the arched convergence receptacle 218 and the rear tire 252 keep the bicycle upright to prevent it from banging around inside the capsule. The arched, converging profile of the receptacle 218 is well suited to snugly receiving a wide range bicycle tires varying in width as well as diameter. In particular, the arched convergence receptacle 218 is shaped to receive tires with varying widths, from street tires to mountain bike tires, carried on a range of standard sized bicycle wheels generally in the range of 26-29 inches in diameter. As shown in FIG. 8, the base panel 208 defines a guide groove 228 to align the rear tire of the bicycle with arched convergence receptacle 218 to facilitate backing the bicycle into the receptacle.

The base panel 208 of the capsule 200 defines a rear tire capture hump 200 that further biases the rear tire of the bicycle into the arched convergence receptacle 218, while also preventing the bicycle from rolling out of the receptacle unless a user intentionally rolls the rear tire over the rear tire capture hump 200 to remove the bicycle from the capsule 200. In addition, the base panel 208 also defines a pair of front tire capture ribs 222a and 222b for stabilizing the front tire of the bicycle and restrict twisting of the handlebars once the bicycle has been backed into the capsule 200 with its rear tire pushed into the receptacle 218. The front tire capture ribs 222a and 222b are positioned to capture the tires of standard sized bicycles with their rear tires received into the arched convergence receptacle 218. The base panel 208 further defines a central rib 224 conferring additional rigidity and shaped to receive a steel mounting plate 226 for bolting the capsule to a foundation, such as flooring or pavement.

The base panel 208 also carries an electronic lock 230 that selectively secures a latch to secure the nose 232 of the pivoting front section 204 to the front portion 234 of the base panel 208 to lock the capsule 200 closed. In this particular embodiment, the base panel 208 is integrally formed with the fixed rear section 205 as a single molded component. A variety of locking mechanisms may be utilized, including an emergency unlock lever 236 or on the base panel 208 connected to a cable that manually unlocks the electronic lock 232. The capsule may also include another emergency unlock lever and cable on the inside of the capsule to allow a person, such as a child, who becomes locked in the capsule to unlock the capsule from the inside. As another option, the capsule may include a manual hard-key cylinder that can be used to unlock the electronic lock without use of the electronic unlock feature. The electronic lock 230 may include a transaction processor, optical drivers license reader, and one or more biometric readers, such as facial recognition camera, fingerprint scanner, retina scanner, and so forth. The electronic lock 230 is operationally integrated into the capsule and associated vehicle surveillance and management described in greater detail below.

While this particular embodiment is specifically tailored for storing a pedal bicycle, the dimensions can be readily adjusted to accommodate other types of bicycles, such as scooters, dirt bikes, motorcycles, and the like. It will be further appreciated the basic design and management system can be further adapted to house other types of vehicles, such as golf carts, go-carts, electric vehicles, all-terrain vehicles (ATVs”), recreational off-highway vehicles (“ROVs”), snowmobiles, jet skis, automobiles, trucks, boats, farm equipment, and so forth.

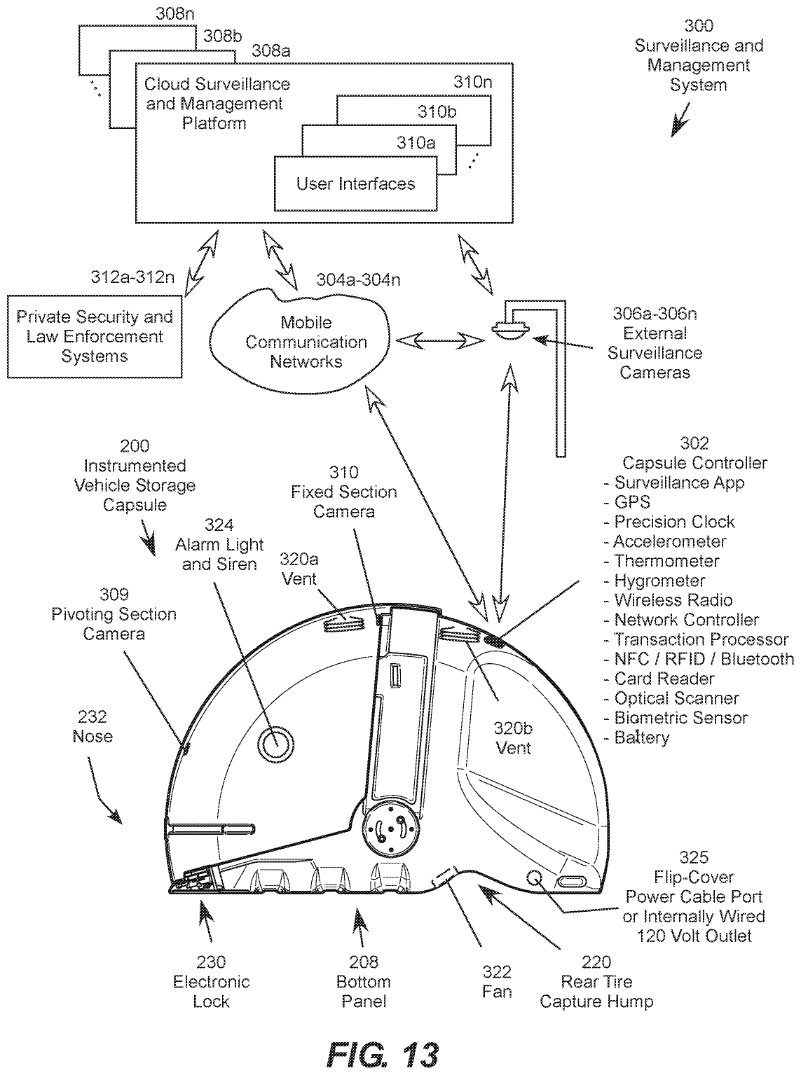

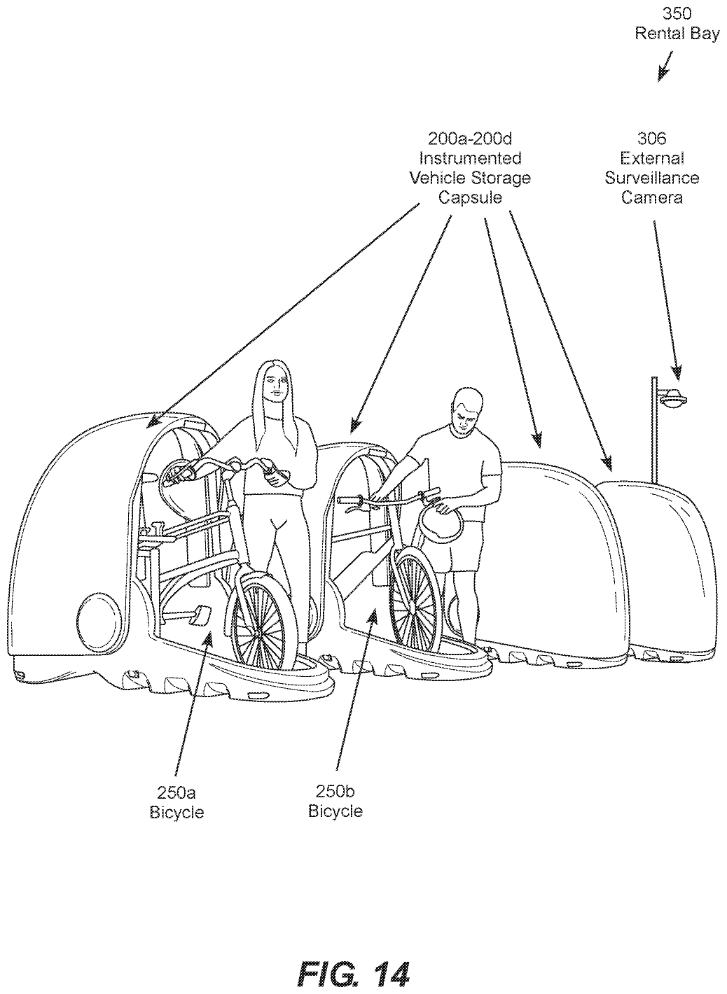

FIG. 13. is an instrumentation diagram for a surveillance and management system 300 for the instrumented vehicle storage capsules 200 and associated vehicles stored in the capsules. FIG. 13 shows the instrumentation of a representative capsule 200, while FIG. 14 shows a representative retail bay 350 containing multiple instrumented vehicle storage capsules represented by the illustrated capsules 200a-200d and associated bicycles represented by the illustrated bicycles 250a-250b. The representative capsule 200 includes a capsule controller 302, which is hard-wired or wirelessly interconnected with other electronic components of the capsule, instrumented bicycles, external surveillance cameras, and other system components. The capsule controller 302 communicates over one or more mobile communication networks 304a-304n, such as the Internet, an overhead data telecommunication network, a private network, or other suitable long-distance communication network. The capsule controller 302 also communicates directly and/or indirectly with one or more external surveillance cameras 306a-306n, which work in concert with the capsule controller 302 to implement security, tampering detection, theft detection, and law enforcement assistance for the capsule 200 and associated bicycle. The capsule controller 302 and the surveillance cameras 306a-306n are functionally interconnected with one or more cloud surveillance and management platforms 308a-308n, which expose user interfaces 310a-310a providing authorized users with visibility, management services and on-demand reporting relating to the capsule 200, a bicycle housed in or paired with the capsule, and other system components. The cloud surveillance and management platforms 308a-308n provide a wide range of surveillance, security, commercial transaction, and facility management services, including interconnection with private security and law enforcement systems 312a-312n to assist in theft deterrence, detection, and law enforcement.

The capsule controller 302 includes a general purpose, specially programmed microprocessor, network management hardware and software, and other components typical of a modern cloud connected computing device. The capsule controller 302 also includes additional components providing functionality pertinent to the capsule and vehicle surveillance and management system, such as a special purpose surveillance application program, global positioning system (GPS), precision clock (e.g., GPS clock), accelerometer (e.g., Micro-Electro-Mechanical System (MMES) gyroscopic motion detector), thermometer, hygrometer, wireless radio, network controller, transaction processor, NFC-RFID-Bluetooth wireless communication hardware and software, a financial card reader, optical scanner (e.g. driver's license scanner), biometric sensor (e.g., facial recognition, fingerprint. retina scanner), battery, and so forth.

The representative capsule 200 includes a number of vents represented by the enumerated vents 320a and 320b located near the top of the capsule. The capsule 200 also includes one or more fans represented by the enumerated fan 322. In this embodiment, the fan 322 is attached to the base panel on the rear tire capture hump 220 to protect the fan from the weather elements while providing intake clearance from the ground under the capsule. The capsule controller 302 detects the internal temperature and moisture content of the air inside the capsule and automatically activates the fan 322 to cool and dry the bicycle and the interior of the capsule as needed. The vents and fans are positioned to intake air from the shaded bottom of the capsule, and exhaust air out to top of the capsule, to protect the fans and efficiently draw cooler air from below and force hotter air inside the capsule out the top of the unit.

The capsule 200 also includes an internal video surveillance camera 309 attached to the pivoting front section 204 positioned to view outward from the front of the capsule when the capsule is in the closed position. The capsule 200 may additionally or alternatively include another internal video surveillance camera 310 attached to the fixed rear section 206 positioned to view out the front of the capsule when the capsule is in the open position. The capsule controller 302 is configured to activate the alarm light and siren 324, activate the attached external surveillance cameras 309 and 310, activate the external surveillance cameras 306a-306n, and transmit an alarm signal to the cloud services platforms 308a-308n whenever it detects unauthorized unlocking, unauthorized entry, or other tempering with the capsule. In addition, the accelerometer motion detector allows the capsule controller 300 to detect any unauthorized attempt to move the entire capsule, automotive crash into the capsule, or other unauthorized movement. The surveillance cameras may be activated to record only at relevant times triggered by user interaction, detected unauthorized activity, or detected movement of the capsule to reduce the amount of data gathered by the cameras. A flip-cover power cable passthrough port or internally wired power 120 V outlet 325 may be included for providing 120 Volt electric power to an e-bike while stored in the capsule.

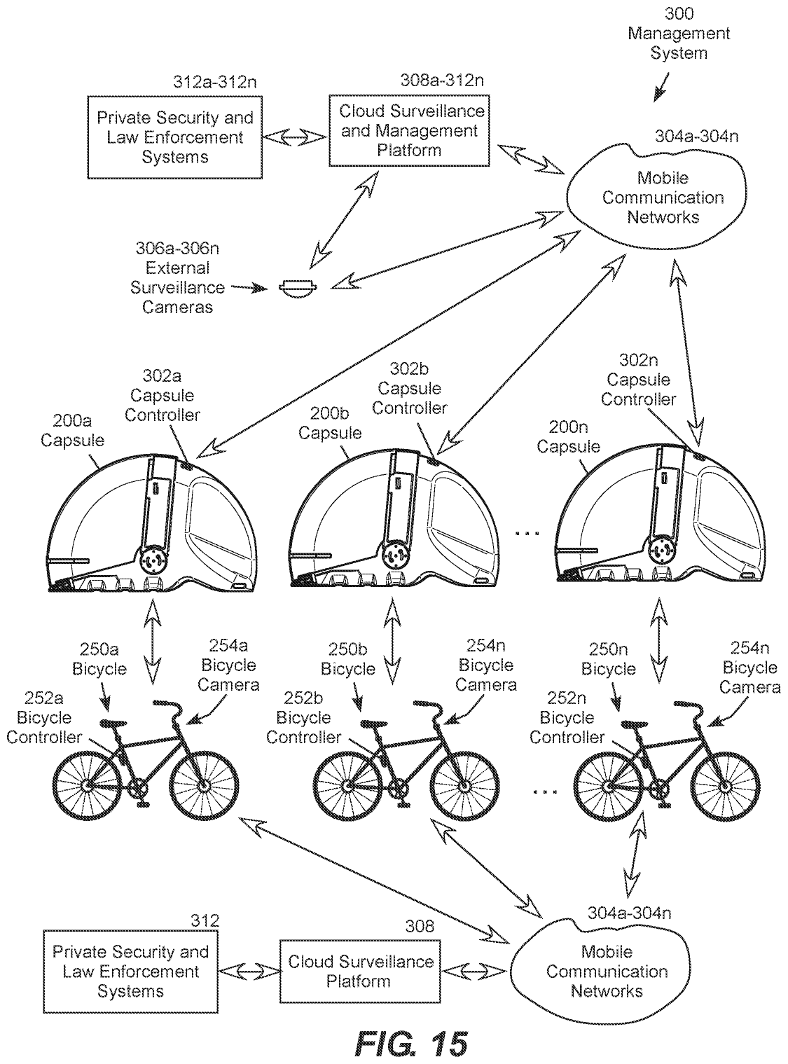

FIG. 15 is a functional block diagram of the management system 300 for multiple the instrumented vehicle storage capsules 200a-200n with capsule controllers 302a-302n and respective assigned bicycles 250a-250n carrying respective bicycle controllers 251a-251n. FIG. 15 illustrates scaling up of the management system 300 described with reference to FIG. 14 to a virtually unlimited number of instrumented capsules and bicycles. The bicycles may be semi-permanently assigned to respective capsules, or they may be dynamically assigned upon docking of a bicycle in a respective capsule. The management also system includes a virtually unlimited number of external surveillance cameras represented by the enumerated cameras 306a-306n.

In general, each capsule is configured to communicate through local NFC/RFID/Bluetooth links and local surveillance cameras without the use of mobile communication networks 304a-304n. Each capsule is also configured to communicate with these and other management system components through the mobile communication networks 304a-304n, which provides flexibility for direct or indirect communication with the cloud services platforms 308a-308n and the private security and law enforcement systems 312a-312n to assist in system-wide surveillance, management, theft deterrence, detection, and law enforcement. Similarly, the bicycles 250a-250n carry respective bicycle controllers 252a-252n. The bicycles may also carry respective forward and rearward facing bicycle cameras 254a-254n, which typically communicate over a Bluetooth channel with the respective bicycle controllers 252a-252n. The bicycle controllers, in turn, communicate with the cloud surveillance and management platforms 308a-308n, as well as the private security and law enforcement systems 312a-312n over the mobile communications networks 304a-304n. The bicycle controllers 252a-252n may also communicate with one or more external surveillance cameras 306a-306n to integrate these components into the system 300.

The bicycle controllers 252a-252n may be deployed in addition to, or in lieu of, the capsule controllers 302a-302n. The functionality described above as deployed by the capsule controllers 302a-302n may be implemented in whole or in part by the bicycle controllers 252a-252n, the cloud surveillance programs 308a-308n, or other cloud service platforms as a matter of design choice.

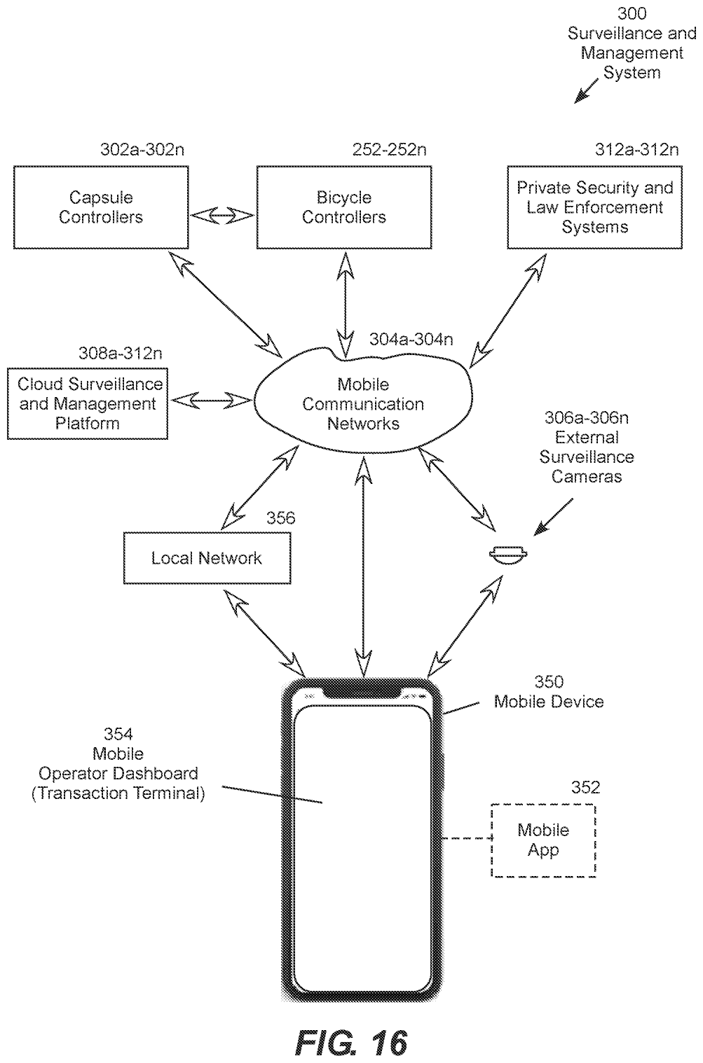

FIG. 16 is a functional block diagram of a mobile device 350 in the management system 300. The mobile device is designed for use in a number of contexts, privately owned capsules, renting bicycles staged for commercial use in capsules, and rental of capsules for storing privately owned bicycles. In this representative example, the mobile device 350 runs a mobile app 352 exposing a mobile operator dashboard 354, which operates as a transaction terminal. Among other functions, the mobile app is operative to open the electronic lock upon receipt of an electronic payment or other reservation scheduling or timing sequence. The mobile operator dashboard 354 can be customized to suit the needs and preferences of each capsule operator, such as capsule owners, renters, frequent renters, and so forth. The mobile device 350 may interconnect with the mobile communication network 304a-304n directly or through a local network 356, for example using a local wifi or ethernet channel. The mobile device 350 may also have the flexibility to connect directly to the mobile communication networks 304a-304n bypassing the local network. The communication network 304a-304n, in turn, interconnects the mobile device 350 with the cloud service platforms 308a-308n, as well as the private security and law enforcement systems 312a-312n.

The mobile app 352 allows the mobile device 350 to operate as a transaction terminal, as well as an interface to the cloud surveillance and management platforms 308a-308n along with the private security and law enforcement systems 312a-312n. Detecting movement of the capsule, an attempted reach of security, or an attempting to register for bicycle rental through the mobile app 352 automatically activates the external surveillance cameras 306a-306n as well as the onboard surveillance cameras 309, 310 to create a video record of the event. The mobile app 350 exposes the mobile operator dashboard 354 allowing the user to register with appropriate credentials and post a payment vehicle for bicycle rental. Completing the financial transaction unlocks the electronic lock allowing the user to remove the rented bicycle from its associated storage capsule. Opening of the capsule without prior authorization is treated as a security breach activating the onboard alarm light a siren 324 in addition to cloud communication of the security breach to the cloud surveillance and management platforms 308a-308n. The private security and law enforcement systems 312a-312n either automatically or upon confirmation of the security breach by the cloud surveillance and management platforms 308a-308n.

The mobile app 252, independently or in concert with the capsule and/or bicycle controllers, provides a number of other services to a bicycle user, such as a local street map with a variety of layers including local street map, bicycle route and speed traveled, theft or accident reporting, on-road repair and troubleshooting, communication technical support, hospital and emergency service locations, local bicycle lane and trail map, local points of interest, local restaurants and shopping, local parks and recreation areas, locations were unoccupied capsules are available for returning the rented bicycle, weather data, emergency data, traveler advisory, calorie counter, etc. It will be appreciated that these examples of types of information that may be accessed through the mobile app are merely illustrative and other types of information, analysis and reports may be provided as a matter of design choice.

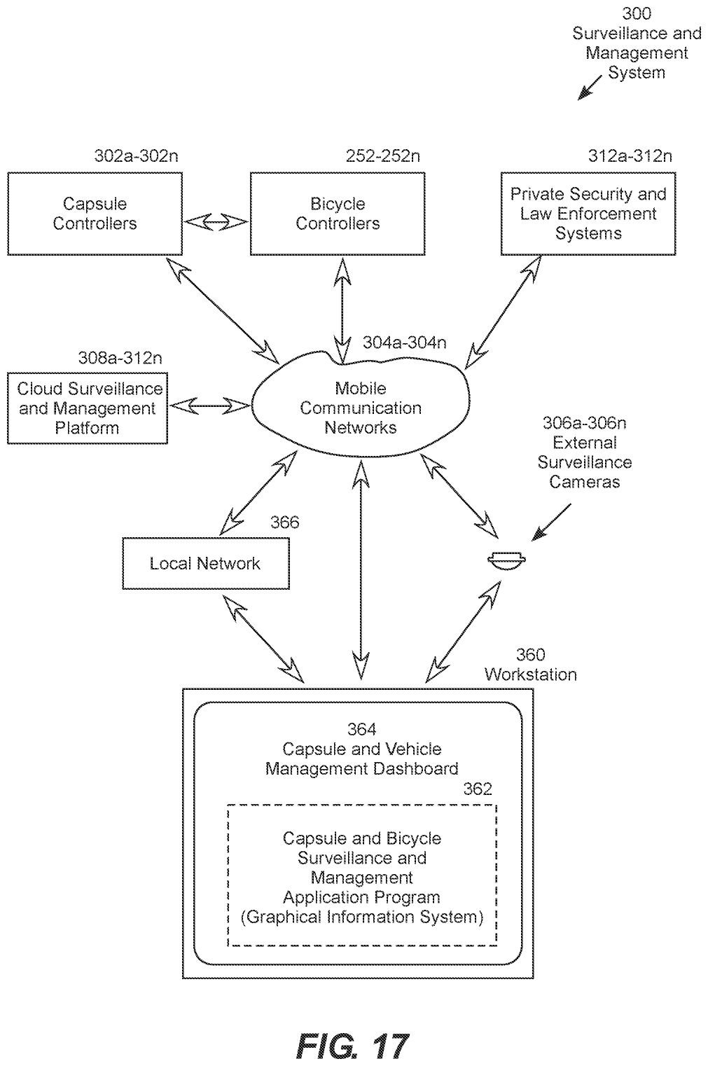

FIG. 17 is a functional block diagram of a workstation 360 in the surveillance management system 300. The workstation is designed for use by an authorized business operator providing commercial bicycle renting services utilizing the instrumented storage capsules. The workstation 360 runs a capsule and bicycle rental surveillance and management application program 362 designed to operate as a graphical information system (GIS) for the business operator. The GIS 362 exposes a capsule and vehicle management dashboard 364 allowing the business operator to access a variety of services provided through the GIS. 362. The capsule and vehicle management dashboard 364 can be customized to suit the needs and preferences of each capsule proprietor, such as large multi-facility bicycle rental organizations, rental shop operators, buildings and landlords offering rental bicycles, parks and other enterprises offering bicyclers for rents. The workstation 360 may interconnect with the mobile communication network 304a-304n directly or through a local network 366, for example using a local wifi or ethernet channel. The workstation 360 may also have the flexibility to connect directly to the mobile communication networks 304a-304n bypassing the local network. The communication network 304a-304n, in turn, interconnects the workstation 360 with the cloud surveillance and management platforms 308a-308n, as well as the private security and law enforcement systems 312a-312n.

The GIS 362 provides a “drill down” set of graphical information system layers associated with the capsules and rental vehicles including a top-level street map showing the current locations of the capsules and bicyclers in the system. Additional layers typically include pictures and serial numbers of the specific capsules, bicycles and controllers, camera surveillance footage of the capsules and bicycles, commercial transactions involving the capsules and bicycles, theft, tampering and damage reports, commercial transaction history, routes traveled, credentials and photos of the renters and other bicycle users, diagnostic information, repair manual information, tools that may be required to interrogate or repair items, instructional repair videos, communication troubleshooting videos, manufacture contact information, specification sheets, assembly diagrams, applicable notices, warnings, and so forth. It will be appreciated that these examples of types of information that may be accessed through the GIS are merely illustrative and other types of information, analysis and reports may be provided as a matter of design choice.

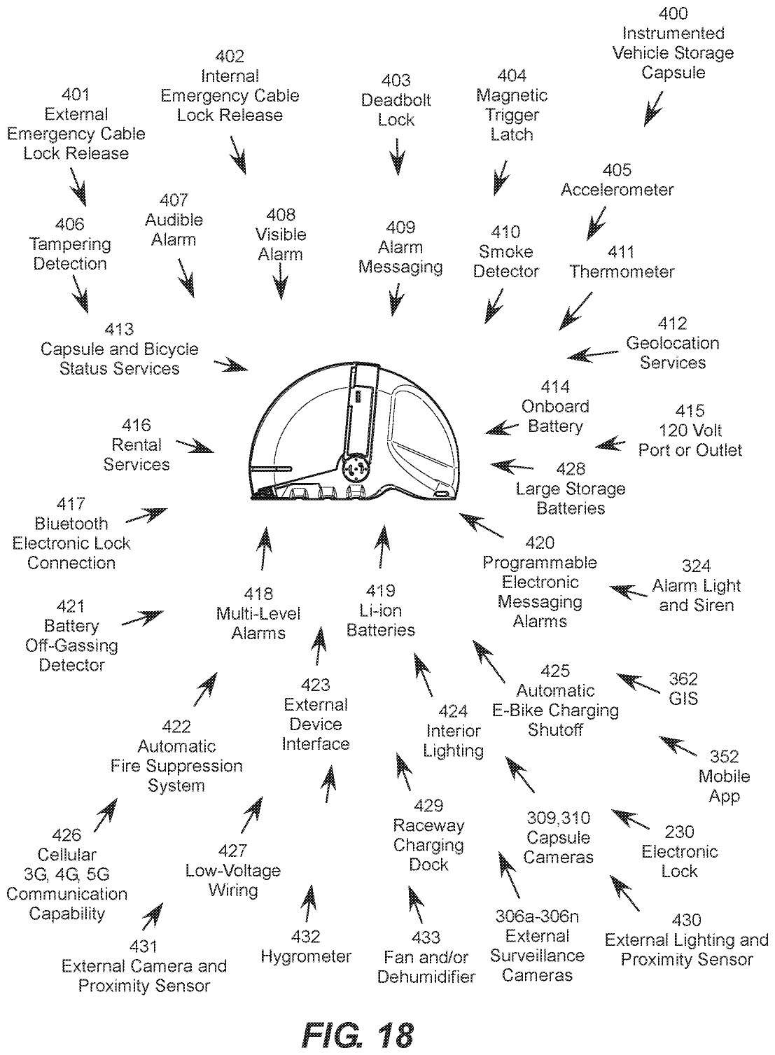

FIG. 18 is a conceptual diagram illustrating features of a representative instrumented vehicle storage capsule 400. Convenient end-user features include locking and unlocking the capsule through the mobile smartphone app 252, which allows the user to share access to the capsule with friends or family via the smartphone app. The capsule may also include an external emergency cable lock release 401 and internal emergency cable lock release 402. The electronic lock 230 includes is a deadbolt lock 403 that latches automatically on closing the front pivoting section 204 via an integrated magnetic trigger latch 404. Unauthorized opening of the capsule. The integrated accelerometer 405 triggers tampering detection 406 an audible alarm 407, a visible alarm 408, and alarm messaging 409 to the cloud surveillance and management platforms 308a-308n when someone tries to break in the capsule with multiple levels of sound from first warning chirp to full screaming alarm. The alarms are also activated by a smoke detector 410 or a thermometer 411 when battery fire is detected inside the capsule. Alarm messaging 409 via the smartphone app 252 provides the user alert messages for a variety of alarm conditions, which may utilize a wifi connection to the capsule controller 302. For example, alarm conditions include detection of someone breaking into the capsule, smoke detector activation, temperature reaching or exceeding a preset temperature, unauthorized movement of the capsule, detection of a crash into the capsule, detection of a crash of a bicycle linked with the capsule, etc. The user also receives an alert via the mobile app when the temperature inside the capsule rises indicating battery fire.

A commercial user may pay the bicycle rental fee, or rent a capsule for storing a privately owned bicycle, through the mobile app 252. The mobile app 252 provides geolocation services 412 indicating a user's capsule and/or an associated bicycle on a map, which may also geolocate other capsules with bicycles for rent, empty capsules where rental bicycles can be returned, repair shop locations, and other points of interest, and provide location guidance and direction indicators and instructions. The mobile app 252 may also provide capsule and associated bicycle status services 413 including messages and mobile app indications whether the capsule has a bicycle located inside, whether the interior of the capsule is wet or dry, whether the capsule is open or closed, whether the capsule is locked or unlocked, when an unauthorized entry has been detected, when unauthorized movement of the capsule has been detected, whether the battery is low. Capsule can be rented from an associated building or owned and managed by a consumer. The onboard battery 414 powers all capsule functions except charging e-bikes, which may be charged by via the flip-cover power cable port or internally wired 415 Volt outlet 325. The user can access all available features through the mobile customer dashboard 354 exposed by the mobile app 252.

Convenient rental services 416 for rental enterprise, landlord, and building management customers include remote locking and unlocking of capsules, emergency and incident notifications from capsules and linked bicycles, capsule notification of the capsule manager if battery is low, audible alarm and electronic messaging notification when someone tries to break in the capsule, and so forth. The capsule manager also receives audible alarm and electronic notification when temperature inside the capsule has reached or exceeded a preset level, whether the capsule has a bicycle located inside, whether the interior of the capsule is wet or dry, whether the capsule is open or closed, whether the capsule is locked or unlocked, when an unauthorized entry has been detected, when unauthorized movement of the capsule has been detected, whether the battery is low. The user can access available features through the capsule and vehicle management dashboard 364 exposed by the GIS 362.

Additional capsule features include, electronic lock connection 417 with sensors and bluetooth and Wifi connectivity, tamper detection with multi-level alarms, easy to replace & recharge Lithium Ion batteries 419 for one year or longer of power independent operation, powerful siren for audible alarms 324, programmable electronic messaging alarms 420 to multiple user devices, and room to store a full sized mountain bike. The capsule also offers encrypted and digitally signed communications 421, scalable backend infrastructure, and detailed data regarding capsule and bicycle utilization, monetization, ROI computation, geolocation, and extended suite of GIS functionality.

The capsule may also be equipped with a smoke detector 410, early battery off-gassing detector 421, temperature and smoke triggered automatic fire suppression system 422 for e-bike battery fires, mobile app external device interfaces 423 for Apple Watch, Strava, Garmin, etc. Additional optional features include interior lighting 424, integrated smart charging for e-bike and bike accessories, lights, Garmin, etc., automatic e-bike charging power shutoff 425 when battery is 100% charged, notifications for bike battery charging status, relay trigger on low power drain, solar panels for perpetual power, integrated powered tire pump, integrated security camera, moisture detection, Apple Wallet integration, NFC tap-to-pay and tap-to-open integration, and automatic mapping/geolocation via GPS or wifi-cell triangulation.

The capsule and bicycle controller may have cellular, 3G, 4G, 5G communication capability 426, and utilize low-voltage wiring 427 with large storage batteries 428. Additional features include a “raceway” charging dock 429 for multiple units (similar to gym machines), external lighting and proximity sensor 430, external camera and proximity sensor 431, charging activity statistics and cost data, hygrometer (humidity sensor 432, fan and/or dehumidifier 433 to dry the bicycles stored in the capsules when the controller determines the air humidity of the air inside the capsule has reached or exceeded a preset level.

The mobile communication networks 304a-304n may include the Internet, the overhead data channels of the public switched telephone network, proprietary telecommunication data channels, satellite links, and other suitable long-distance data networks. Local networks typically include a selection of access points, relay points, wifi routers, hot spots, cellular modems, ethernets, power-over-ethernet (PoE) devices, DHCP servers, gateways, data switches, and other suitable network operations and management components as may be deployed in different network configurations. Fixed workstations are typically configured to access the cloud computers over local networks to interconnect with the mobile communication networks. Mobile user devices can generally use these same facilities for online connectivity, while often having flexibility to directly interconnect with the mobile communication networks, bypassing the local networks when accessing the cloud services.

The cloud surveillance and management platforms 308a-308n, capsule controllers 302a-302n, and bicycle controllers 252a-252n may be general purpose, specially programmed network computing devices. Although the surveillance and management platforms 308a-308n are depicted as located at a central control center, they may be located at any desired location in the “cloud” including, for example, as controllers in one or more of the rental and repair stores. The user devices 350, 360 may be general purpose, specially programmed fixed or mobile monitoring stations, computer workstations, laptop computers, tablets, mobile smartphones, wearable computers, and other enterprise and personal computing devices suitable for accessing the cloud services. The user devices run application programs, mobile apps, device drivers, and other specially programmed software to access the cloud services over the local and inter-facility networks.

Each computing device in the surveillance management system 300 typically includes general purpose computer components including a processor, a computer readable storage medium storing non-transitory computer-executable instructions, and network access and management equipment that, when executed by the processor, causes the controller to perform operations described in this disclosure. The processor may be, for example, a central processing unit (“CPU”), sometimes referred to as a controller, microcontroller, processor or similar designation, together with other motherboard, computer bus, random access memory, solid state or other non-volatile memory, peripheral device drivers, and interface components typically included in general purpose, specially programmed user devices, network devices, and cloud computing platforms.

It will be recognized that the shapes and forms noted herein and in the drawings are not limited or required for function, and may be realized by other shapes, forms or geometries for vehicle storage capsule 200 or the elements discussed herein. For example, the rear tire capture hump 220 (shown smoothly sloped and continuous side-to-side) or pinched rear portion 216 (shown with a smooth concave side form) or guide groove 228 (shown arc-formed in the hump 220) may each have any other shape effective to secure the tire or guide the tire in a helpful manner. Thus, rear tire capture hump 220 may be for example a geometric triangle (three-linear sides with a flat base on the ground), or a pyramidal-shape with flat-slopes (not curves), or only in a central portion or any other divergent shape suitable to the tire-form. Similarly, pinched rear portion 216 may be in any shape to guide the tire, for example a U-shaped protrusion extending from linear planar walls, or an arc-lip form extending downwardly from a top surface of vehicle storage capsule 200. Similarly, guide groove 228 may be V-shaped, or a series of gripping protrusions on the surface of hump 220 or any other form to aid in tire-arrangement to reach the rear tire pinched rear portion 216.

Along a similar understanding the bottom panel 208 is shown with a geometry and tire capture ribs 220a, 220b, but may be of other shapes and forms without departing from the scope and spirit of the present invention and for example may be fully planar on an outer surface and with inner fixtures without departing from the disclosure, or may have ribs that are rectangles with linear planar walls and perpendicular angles (not smoothly curved) all within the scope of the disclosure.

Also the overall vehicle storage capsule 200, shown in a smooth arch form, may be in any other form effective to achieve the claims and functions herein, for example a rectangular geometric form with planar sides and a lift up front hinge.

As will be understood by those of skill in the present art having studied the current disclosure, the present invention is not limited to the shapes herein but fully encompasses other arrangements, shapes, and geometric forms effective to achieve the claims herein. Thus it will be understood that the shapes shown herein are not functionally limiting and my have an ornamental aspect as well.

The drawings are in simplified form and are not to precise scale unless specifically indicated. The words “couple” and similar terms do not necessarily denote direct and immediate connections, but also include connections through intermediate elements or devices. Certain descriptors, such “first” and “second,” “top and bottom,” “upper” and “lower,” “inner” and “outer,” or similar relative terms may be employed to differentiate structures from each other. These descriptors are utilized as a matter of descriptive convenience and are not employed to implicitly limit the invention to any particular position or orientation.

Those skilled in the art will recognize that it is common within the art to describe devices and/or processes in the fashion set forth in this disclosure, and then use engineering practices to integrate such described devices and/or processes into data processing systems. That is, at least a portion of the devices and/or processes described can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities).

A typical data processing system may be implemented utilizing any suitable commercially available components, such as those typically found in data computing and/or communication and/or network computing/communication systems. All of the technology described in this disclosure is suitable for implementation using commercially available computing devices, such as network servers operated by system administrators and smartphones or personal computers operated by members and customers. These computing devices may be interconnected via the Internet, mobile telephone voice and data system, or other data suitable network.

This disclosure sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components may be combined to achieve a particular functionality can be seen as “associated with” each other such that the desired functionality is achieved, irrespective of architectures or intermediate components. Likewise, any two components so associated can also be viewed as being “connected”, or “coupled”, to each other to achieve the desired functionality, and any two components capable of being so associated can also be viewed as being “functionally connected” to each other to achieve the desired functionality. Specific examples of functional connection include but are not limited to physical connections and/or physically interacting components and/or wirelessly communicating and/or wirelessly interacting components and/or logically interacting and/or logically interacting components.

It will be appreciated that layers, features, elements, etc., depicted herein are illustrated with particular dimensions relative to one another, such as structural dimensions or orientations, for example, for purposes of simplicity and ease of understanding and that actual dimensions of the same differ substantially from that illustrated herein, in some embodiments. Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

While particular aspects of the present subject matter have been shown and described in detail, it will be apparent to those skilled in the art that, based upon the teachings of this disclosure, changes and modifications may be made without departing from the subject matter described in this disclosure and its broader aspects and, therefore, the appended claims are to encompass within their scope all such changes and modifications as are within the true spirit and scope of the subject matter described in this disclosure. Although particular embodiments of this disclosure have been illustrated, it is apparent that various modifications and embodiments of the disclosure may be made by those skilled in the art without departing from the scope and spirit of the disclosure. Accordingly, the scope of the disclosure should be limited only by the claims appended hereto.

The invention claimed is:

1. A bicycle storage capsule, comprising
a fixed rear section;
a pivoting front section;
a pivot connecting the fixed rear section and the pivoting front section allowing the pivoting front section to rotate about the pivot between an open position and a closed position, wherein the fixed rear section and the pivoting front section are nested in the open position and un-nested in the closed position;
a base panel supporting the fixed rear section, the pivoting front section, and the pivot, wherein the base panel, the fixed rear section, and the pivoting front section form a selectively openable and closable capsule for removably storing a bicycle;
the fixed rear section forming a pinched rear portion defining an arched convergence receptacle for receiving a rear tire of the bicycle;
the base panel defining a rear tire capture hump for biasing the rear tire of the bicycle into the arched convergence receptacle to support the bicycle in an upright position on the base panel.

2. The bicycle storage capsule of claim 1, wherein the base panel is integrally formed with the fixed rear section as a single molded component.

3. The bicycle storage capsule of claim 1, wherein the base panel further defines a guide groove for aligning the rear tire of the bicycle with the arched convergence receptacle.

4. The bicycle storage capsule of claim 1, wherein the base panel further comprises one or more tire capture ribs for stabilizing a front tire of the bicycle when the rear tire of the bicycle is received in the arched convergence receptacle.

5. The bicycle storage capsule of claim 1, further comprising a handle for assisting in manual rotation of the pivoting front section to open the bicycle storage capsule.

6. The bicycle storage capsule of claim 1, further comprising an accessory rack on an interior wall of the bicycle storage capsule.

7. The bicycle storage capsule of claim 1, further comprising an emergency release lever and cable for manually unlocking the electronic lock.

8. A vehicle storage capsule, comprising
a fixed rear section;
a pivoting front section;
a pivot connecting the fixed rear section and the pivoting front section allowing the pivoting front section to rotate about the pivot between an open position and a closed position, wherein the fixed rear section and the pivoting front section are nested in the open position and un-nested in the closed position;
a base panel supporting the fixed rear section, the pivoting front section, and the pivot, wherein the base panel supports the fixed rear section and the pivoting front section forming a selectively openable and closable capsule for removably storing a vehicle;
an electronic lock releasably attaching a nose of the pivoting front section to the base panel to selectively lock the capsule;
a mobile app running on a mobile device operative to wirelessly unlock the electronic lock.

9. The vehicle storage capsule of claim 8, wherein the mobile app is operative to open the electronic lock upon receipt of an electronic payment.

10. The vehicle storage capsule of claim 8, further comprising a surveillance camera attached to the pivoting front section positioned to view out from a front of the vehicle storage capsule when the vehicle storage capsule is in the closed position.

11. The vehicle storage capsule of claim 8, further comprising a surveillance camera attached to the fixed rear section positioned to view out from a front of the vehicle storage capsule when the vehicle storage capsule is in the closed position.

12. The vehicle storage capsule of claim 8, further comprising an external surveillance camera positioned to view the vehicle storage capsule activated upon user interaction with the vehicle storage capsule through the mobile app.

13. The vehicle storage capsule of claim 8, further comprising a controller, a thermometer, a vent, and a fan configured to automatically blow air through the vehicle storage capsule upon determining that an air temperature inside the vehicle storage capsule detected by the thermometer has reached or exceeded a preset temperature.

14. The vehicle storage capsule of claim 8, further comprising a controller, a hygrometer, a vent, and a fan or dehumidifier, wherein the controller is operative to automatically activate the fan or dehumidifier upon determining that an air humidity inside the vehicle storage capsule detected by the hygrometer has reached or exceeded a preset level.

15. The vehicle storage capsule of claim 8, further comprising a controller, an alarm light, and a siren, wherein the controller is operative to automatically activate the alarm light and the siren upon determining unauthorized opening of the vehicle storage capsule by the electronic lock.

16. The vehicle storage capsule of claim 8, further comprising a controller, an alarm light, a siren, and an accelerometer, wherein the controller is operative to automatically activate the alarm light and the siren upon determining unauthorized movement of the vehicle storage capsule by the accelerometer.

17. A surveillance and management system, comprising:
a vehicle storage capsule comprising an electronic lock and a controller operative to communicate with a cloud surveillance and management platform over a mobile communication network;
a mobile app running on a mobile device operative to communicate an electronic payment of a rental fee for a vehicle stored in the vehicle storage capsule to the cloud surveillance and management platform over the mobile communication network;
the cloud surveillance and management platform operative to transmit an unlock signal to the electronic lock unlocking the vehicle storage capsule upon receipt of the payment of the rental fee through the mobile app;
the electronic lock operative to detect an unauthorized unlocking of the vehicle storage capsule and send a notification of the unauthorized unlocking to the cloud surveillance and management platform over the mobile communication network;
the cloud surveillance and management platform operative to transmit a signal notifying one or more private security and/or law enforcement system of the unauthorized unlocking.

18. The surveillance and management system of claim 17, further comprising an internal surveillance camera attached to the vehicle storage capsule, wherein:
the controller is operative to activate the internal surveillance camera and transmit video captured by the internal surveillance camera in response to detection of the unauthorized unlocking to the cloud surveillance and management platform;
the cloud surveillance and management platform is operative to transmit the video captured by the internal surveillance camera in response to detection of the unauthorized unlocking to one or more of the private security and law enforcement systems.

19. The surveillance and management system of claim 17, further comprising an external surveillance camera detached from the vehicle storage capsule, wherein:
the controller is operative to activate the external surveillance camera and transmit video captured by the external surveillance camera in response to detection of the unauthorized unlocking to the cloud surveillance and management platform;
the cloud surveillance and management platform is operative to transmit the video captured by the external surveillance camera in response to detection of the unauthorized unlocking to one or more of the private security and law enforcement systems.

20. The surveillance and management system of claim 17, further comprising an alarm light and siren, wherein the controller is operative to activate the alarm light and siren in response to the unauthorized unlocking.
